(19) United States
(12) Patent Application Publication
(10) Pub. No.: US 2002/0126154 A1
(43) Pub. Date: Sep. 12, 2002

(54) Method for displaying and scrolling data including display status feedback

(76) Inventor: Edwin George Watson, Voorhees, NJ (US)

Correspondence Address: EDWIN G. WATSON, 50 BUTTONWOOD CT., VOORHEES, NJ, 08043, US

(21) Appl. No.: 09/804,385

(22) Filed: Mar. 12, 2001

(51) Int. Cl. G06F 3/14

(52) U.S. Cl. 345/784; 345/765

(57) ABSTRACT

A method and apparatus for providing continuous viewing of data when a scroll or view change operation is performed while displaying data in a data display system where the data file is larger than can practically be displayed in the desired display region. The invention includes novel methods for providing feedback means to the user for the purpose of guiding the users eye to continue viewing new data as it is presented in the updated display view.

### CROSS REFERENCE TO RELATED APPLICATIONS Disclosure submitted under the U.S. Pat. TO disclosure program Disclosure Document # 453185, 03/18/99.

### STATEMENT REGARDING FEDERALLY SPONSORED RESEARCH OR DEVELOPMENT

Not Applicable.

### REFERENCE TO A MICROFICHE APPENDIX

Not Applicable

### BACKGROUND OF THE INVENTION

1. Field of the Invention

This invention generally pertains to a computer or information display system and more particularly to a system and methods to display portions of a data set on a viewable device and includes methods to provide visible feedback for the user discern between data which has previously been displayed as compared to new or previously undisplayed data.

2. Description of the Prior Art

A typical computer system and the like consists of a display device which has a function to display data which may reside inside the memory of the computer, or data which may enter into the computer by other means. Often, when a data file is selected to be displayed, said data file residing in the memory or data buffer is larger than the specified viewable area of the display device is capable of displaying. As a result a system is required to allow the user to access various portions of the data buffer, as the user sees fit.

Well known to the art is the application of scroll bars in a Graphical User Interface, which act as the interface in which the user can direct the system to display the desired portion of the substantially large data buffer in the visible area of the display. Said scroll bars typically employ a point and click device, such as a mouse to interact with sensitive areas of the display screen, which when activated by a mouse click for example, result in a command being generated and sent to the display controller, ultimately resulting in a view change in the display. Said scroll bars typically are arraigned in a vertical and horizontal fashion, providing vertical and horizontal control respectively. Functionality of the scroll bars include gross or fine movements of the data in the display region, which requires movement of said data from the data buffer or storage area to the display area. Depending on the section of the scroll bar pointed to and clicked on, the scrolling function can be an incremental line by line movement of fresh previously undisplayed data to the display, or page by page movement of fresh data to the display, where a page is considered substantially the amount of data in the display area. The scrolling motion can be, but is not limited to, a forward or backward direction relative to the data buffer, and in a vertical or horizontal direction. The scroll bar typically consists of a multifunctional slider block of which one function is to show the position of the viewed data with respect to the whole of the data in the buffer by the visible position of the slider block in the scroll bar. A second function of the slider block is to show the relative size of the viewed data to the whole buffer size, by displaying an adjusted size of the slider block within the scroll bar. A third function of the slider block is to be grabbed by the pointer device an slid along the slider bar thus displaying portions of the data buffer in proportion to the relative position of the slider within the scroll bar. Scrolling page by page, or jump scrolling is typically accomplished by a single click of the pointing device in the area of the scroll bar adjacent to the slider block on the side of the slider block pertaining to the direction that the user wishes to scroll. When scrolling page by page the system determines what the current size of the viewable area is and acquires from the data buffer a substantially equal amount of fresh data, in sequence with the currently displayed data, and then displays that data to the display area. The new data mostly displaces the currently viewed data and thus provides a contiguous feed of data to the display. In the previous procedure, when the end of the data buffer is approached, in any direction, the last block of fresh data is typically smaller than the visible area of the display, resulting in the visible area of the display being only partially filled by fresh data after a page by page scroll event. The user while viewing the data usually can expect fresh data to be displayed near the top of the viewable area, whereas the fresh data, if smaller than the visible display area, will begin somewhere in the middle of the display area, resulting in an interruption in the users continuous viewing of the data.

As an example of the above mentioned scenario, a user may typically request to the computer operating system to view a particular data file, which may consist of many lines of text, being greater than the capacity of the currently configured display device. Next, a typical graphical interface viewing and scrolling tool appears which displays a certain number of lines of said data file. After the user has read down through the visible lines of data, a request is generated by the user to the scrolling device to move new data into the viewing area. The user may issue a command to execute a full-page jump which typically replaces all of the data currently visible on the display with the subsequent data in the file which has yet to be displayed in the current viewing session. The user must then move their eyes from the bottom to the top of the viewing area, to a position where it is expected to resume reading fresh lines of data. For many reasons, including nearing the end of the data file and variations in file content, when a full-page jump is executed, fresh data is not positioned at the location near the top of the viewing area where the user might expect it to be. Therefore, there results a discontinuity in resuming viewing of the data, and the users eye may be temporarily lost while trying to locate where to resume viewing the fresh data. It is also known in the art that small portions of the old or previously displayed data, for example one line of text, are in some cases, kept in the display after a page jump operation, but moved to the top of the display, followed by the fresh data, to assist in the users to reacquire viewing the data by re-reading and recognizing the last line. The user must still, however, find the beginning of the fresh data before continuing viewing. In addition to the full page jump, there are multiple methods which may be used to scroll through a data file, including holding down on a line by line scroll arrow, resulting in a multiple of fresh lines of data sequentially scrolling into the screen until the button is released. In any method of issuing a scroll or view change operation, it becomes necessary for the users eye to reacquire the position on the display field where resumption of viewing of data can occur. Therefore it would be beneficial to the user of graphical interfaces which may employ scrolling tools, to have a method to clearly identify previously displayed data from newly displayed data, so the users eye can instantly pick up where it left off and continue viewing the desired data file with minimal disruption.

### BRIEF SUMMARY OF THE INVENTION

It is the object of this invention to provide a novel means to supply visual feedback to the user of a data display system, which will assist in the progressive display and viewing a data file, and thus satisfy the needs of the art.

This invention allows the user to, after a view change operation, easily find the start of fresh, previously undisplayed data, with respect to previously displayed data, for any size data buffer or viewable display area. The invention also includes means to collect and process view status information during the viewing process, thus directing the said visual feedback means. The invention further provides means to continue said visual feedback by automatically updating the process at all view change operations. The invention further provides means to capture, organize, and store said status information thus forming a collection of metrics in reference to the viewing session. Said metrics can be used, for example, to survey usage and preferred sections of data files viewed by one or more users.

### BRIEF DESCRIPTION OF THE DRAWINGS

The current invention is best understood when read in conjunction with the attached drawings as outlined below:

FIG. 1 depicts a typical process of displaying a data file with separate representations of different views a user will see as the user progresses or scrolls through said data file. Included are drawings depicting the structure of a typical data file, and representations of typical viewing areas corresponding to viewing different sections of said data file.

FIG. 2 shows a flowchart of a typical process for displaying a data file and scrolling through said file with visible feedback.

### DETAILED DESCRIPTION OF THE INVENTION

This invention comprises a system and methods for providing viewing of data in a typical computer system and the like. Furthermore when viewing a data file, and in the process of performing view change operations to display subsequent portions of said data file, which is essentially larger than the current display region, indicators or markers are displayed which alert the operator as to a difference between those portions of the data set which have been previously viewed and those portions of the data set which have not been previously viewed. The invention also includes detection means which can collect and record status of the data set with regard to display, means to process said status information, and means to direct the placement of visual markers on or near the data display, so as to provide the previously described guidance to the viewer as to the location on the display where the new data begins. The invention also includes means to archive and retrieve said status information and establish metrics or statistics relating to viewing operations performed on said data file. Such information may be valuable to gather statistics on data file usage and more particularly which sections of said data file are accessed more frequently and total elapsed time spent on said section. Such information may also be used to restart a viewing session, thereby retaining the differentiation information from the previous session.

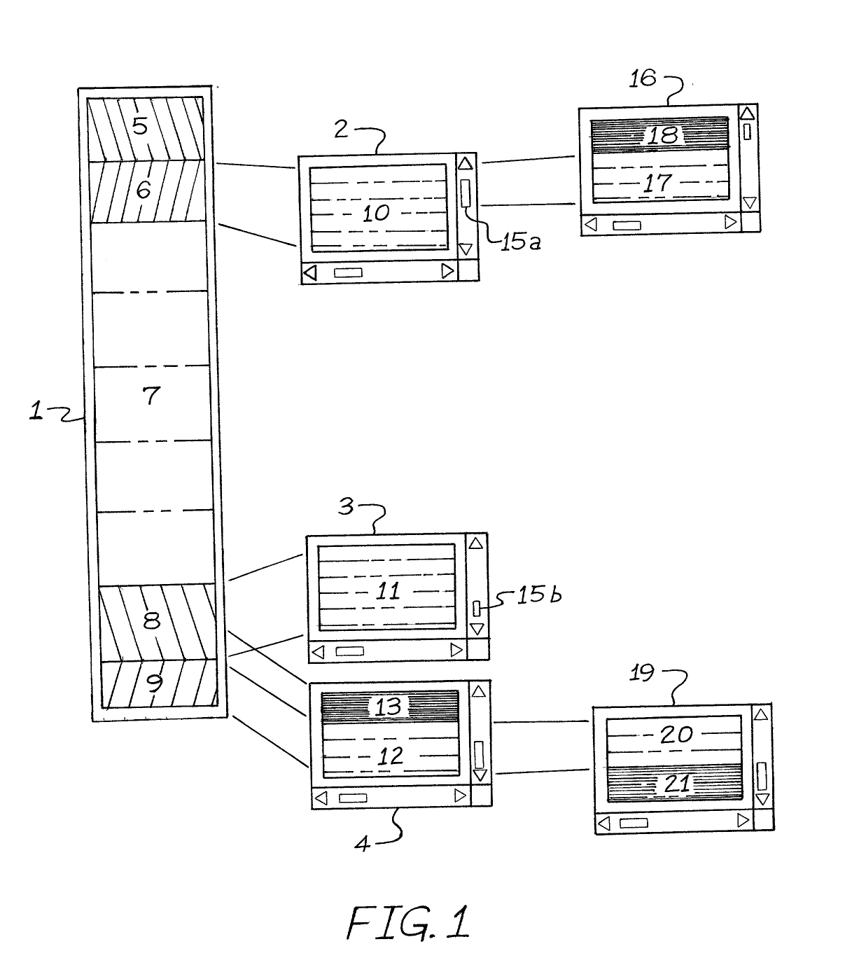

FIG. 1 depicts the preferred embodiment of the disclosed invention and is a pictorial overview of a user interactive session showing relationships between said data buffer 1 and viewable display areas 2, 3, 4, 16, and 19 at various locations in the viewing process scrolling through said data buffer 1. When a user has started a viewing session and may travel from top to bottom of data buffer 1, a viewable display area 2 is shown as it would display a portion of data buffer 6, which is substantially near the top of data buffer 1, and is detected and identified by the system as the currently displayed data 6, and in this particular instance as never before displayed data, and is displayed as such on the display 10, with the size of the data essentially corresponding to the size of the viewable area. Scroll bars and controls 15a preferably are employed by the user to invoke moving said data buffer 1 through said display area 2, and in this operational example where said data buffer 1 was originally accessed from the top, prior to displaying the currently displayed data 6, having earlier displayed a set designated previously displayed data 5. Similarly data 7, having never been displayed is designated by the algorithm as never displayed data. As a user may travel toward the end of said buffer 1, to a currently displayed data set 8, which displays on a display area 3 as displayed data 11, all areas at this time in the course of events that were previously displayed are designated as previously displayed data. From this given position in said data buffer, as the user may choose to initiate a full page scroll down in the display area 3, using controls 15b, whereas the remaining data in said data buffer 1, currently designated as never displayed data 9 is smaller than that is required to fill a display area, the scroll action results in a display area 4 with said never displayed data 9 being displayed in area 12, and previously current and now previously displayed data 8 being partially displayed in display area 4 including a means of marking, shading, or otherwise differentiated displayed data 13. Said differentiating means allows easy and accurate continuation of viewing by the user whereas the new data 12 is not displayed with a starting location as expected by the user, as may have been the norm for previous scroll events. A particular display area 16 shows currently displayed data 17 and previously displayed data 18 which may occur in the event the user using scrolling means, scrolls backward from a fully current display 10 to redisplay data designated as previously displayed data 5.

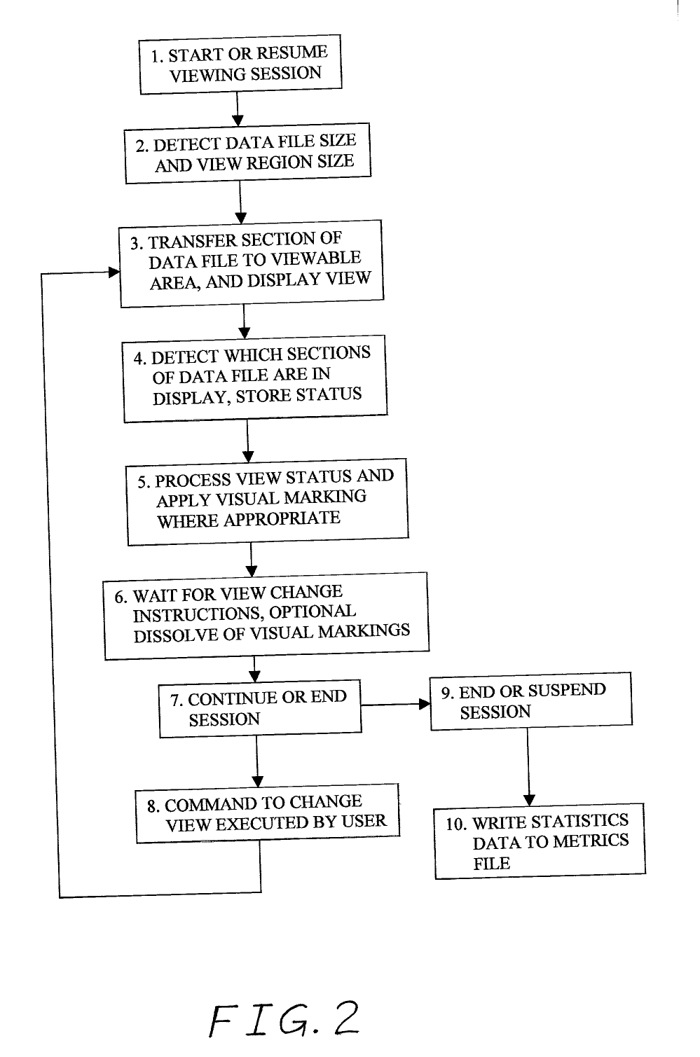

FIG. 2 outlines a flow chart describing a process which substantially characterizes a typical data file viewing session incorporating methods concurrent with the invention disclosed.

1. A command is given to start or resume data viewing session.

2. The data file size and the view region are detected.

3. First section of data is transferred from storage location to viewable area of display screen and displayed.

4. Status information is recorded, including lines currently displayed, lines never displayed, lines previously displayed, and total time lines are displayed.

5. Visual marking means or shading applied to viewable area based on status and preference settings.

6. Wait for new view change instructions, and optional fade or dissolve of marks or shading occurs to remove marking or shading after a predetermined time or in response to a user input.

7. Decide to continue or end view session.

8. View change operation executed, including a full-page jump, partial page jump, multiple line scroll, single line scroll, or jump ahead commands. Next, GO TO STEP 3, and view is updated in display region.

9. Continue looping in response to view change requests until command is given to terminate viewing session.

10. Write statistics data to metrics file for survey info or restart.

In a different embodiment, returning to FIG. 1, a display area 19 incorporates an algorithm which when determining that the requested previously undisplayed data 9 requires less area than the display area 19 offers, said algorithm displays the previously undisplayed data 9 at substantially the expected predetermined position in the area, and further generates and displays null or fill data 21 to fill the remainder of the area. Yet another embodiment incorporates an algorithm means which resizes the viewable area to adjust to incoming buffer data which may be less than that amount needed to substantially fill the viewable area. Shading or other identification means may be used in conjunction with said repeat location method to Her identify new and/or old data.

In another embodiment of the disclosed invention, the system identifies or relocates data in the viewable display area when said viewable display area is changed by resizing, or stretching or the like. Identification of said data is similar to said methods of determining fresh from previously displayed data, as detailed above. Relocation of data is similar to that described above whereby fresh data is routinely located on one predetermined portion of the viewable area.

Methods to mark or differentiate said displayed data and the status thereof can be, for example but not limited to, the background shading or gradient shading of said data which has just previously been displayed as a result of the last scroll input command, this will identify the user that said data was available for viewing in the previous configuration of the display area, and may have already been viewed by the user, whereas the non shaded data is freshly retrieved data and typically the user can direct their eyes to that area of the display for resumption of viewing. Other means not specifically mentioned can also be employed to achieve the same differentiation means and are within the spirit of the invention, including but not limited to bold lettering, underlining, font changes, inverse video, flashing markers, frames, outlined regions, and spacing changes. Furthermore, the invention also includes means to set, store, and change preferences related to the methods disclosed in this invention.

This invention is not limited to a viewing and scrolling operations occurring in a single viewing area, but is applicable for multiple viewing areas which may occur simultaneously and which may interact with the same data file or with multiple data files. Furthermore this invention is not limited to scrolling in one direction, differentiation may be applied to scrolling in all directions of the display.

In another embodiment of this invention, the differentiation marking persists when scrolling commands which are considered small are entered, which may for example roll back the display, by a predetermined number of lines, and thus the marking from the prior operation remains as before the small move. Furthermore the differentiation means is also reversible, whereby reversing the viewing instructions, by applying the exact opposite command of the previous command, the view and differentiation means reverts to the prior display.

In yet another embodiment, the invention is not limited to data file viewing only, but applies to all graphical display, creation, and manipulation of data files, including building, editing, deleting, and combining data files. The invention may also work in conjunction with known selection procedures for file editing, whereas shaded regions which are identified by the differentiation means may be converted to a selection field in a file editing session. Furthermore the invention is not limited to text data files, but is applicable to all types of data files including, but not limited to, graphics, menus, program control windows, photos, audio, video, HTML, and any other displayable format.

Still another embodiment of the present invention includes a operation mode where updating the view and accordingly the associated differentiation means is not dependant on a manual view change operation. Automatic means to scroll through a given data file may be employed which performs the view operation without specific manual user commands.

Yet another embodiment of the present invention includes differentiation means which are capable of distinguishing between multiple previous view change or scrolling operations. For example, if three consecutive view change operations were performed, and because of the nature of the operation sections of the data file are still visible in the viewable area from all three previous operations, then distinguishable markings are used to differentiate between all three types of previous displayed data. In addition all multiple steps are reversible.

Although the invention is described with respect to a preferred embodiment, modifications thereto will be apparent to those skilled in the art, and such modifications can be made while still retaining the spirit of the invention: Therefore the following claims are drafted to describe the scope of the invention and any such modifications falling within the spirit of the invention.

What is claimed is:

1. A method of displaying data in an information display system comprising:
differentiation means to distinguish to the user portions of said data which has been displayed in at least a section of a display screen prior to one or more view change operations, from that portion of said data which was essentially undisplayed prior to said view change operation
continuation means to increment said differentiation of said data with subsequent updates of any views.

2. The method of claim 1, wherein said differentiation means includes graphical shading means, in any direction, to mark data sections.

3. The method of claim 1, wherein said differentiation means includes features such as lines, bars, arrows, frames, outlines, special fonts, variable spacing, flashing characters, and the like, which after a view change operation, are displayed on said viewable area and directs the eye to continue viewing at the point of newly displayed data.

4. The method of claim 1, further comprising:
segregation means to mark previously displayed data with at least one substantially adjacent character field in proximity to data field, which after a view change directs the eye to continue viewing at the point of newly displayed data.

5. The method of claim 1, wherein said differentiation means includes dissolve means which allow said differentiation means to fade away from said display area after a certain amount of elapsed time or a certain number of subsequent viewing operations.

6. The method of claim 1, further comprising:
switching means to toggle said differentiation means between states where previously displayed data is marked to where previously undisplayed data is marked.

7. The method of claim 1, further comprising:
metrics means to gather and process statistics from the viewing session, including but not limited to; sections of said data file that were displayed, sections of said data file that were not displayed, elapsed time said sections of said data file were displayed, and number of times said sections were displayed.

8. A method of displaying data in an information display system having a display screen and a scrolling means, where if said data file is larger than current display region, scrolling or view changes allow piecewise display of said data file comprising:
detection means to detect status of said data portions in said display
indication means to mark or visually differentiate said display status

9. The method of claim 8, further comprising:
continuation means to increment said indication means of said data with subsequent updates of the view.

10. The method of claim 8, wherein said indication means includes graphical shading means, in any direction, to mark data sections.

11. The method of claim 8, wherein said indication means includes features such as lines, bars, arrows, frames, outlines, special fonts, variable spacing, flashing characters, and the like, which after a view change operation, are displayed on said viewable area and directs the eye to continue viewing at the point of newly displayed data.

12. The method of claim 8, further comprising:
segregation means to mark previously displayed data with at least one substantially adjacent character field(s) in proximity to data field, which after a view change directs the eye to continue viewing at the point of newly displayed data.

13. The method of claim 8, wherein said indication means includes dissolve means which allow said indication means to fade away from said display area after a certain amount of elapsed time or a certain number of subsequent viewing operations.

14. The method of claim 8, further comprising:
selection means whereby results of said differentiation means can be converted to selected data in conjunction with an editing system which may use said selected data sections to perform editing procedures.

15. The method of claim 8, further comprising:
metrics means to gather and process statistics from the viewing session, including but not limited to; sections of said data file that were displayed, sections of said data file that were not displayed, elapsed time said sections of said data file were displayed, and number of times said sections were displayed.

16. The method of claim 8, further comprising:
adjustment means to provide continuous viewing by forcing newly displayed data to start at essentially one begin location in said display region, and subsequently adjusts said viewing area to accommodate varying size data sections, or append null data to said data file to allow said newly displayed data to start at said begin location.

17. An information display system having a display screen and a scrolling means, comprising:
differentiation means to distinguish to the user that portion of the data which has been displayed in at least a portion of said display screen, prior to one or more view change operations, from that portion of said data which was undisplayed prior to said view change operation
means to increment said differentiation of said data with subsequent updates of any views
means to return to the previously viewed data.

18. The method of claim 17, further comprising:
detection means to detect and store status of data with regard to display in session.

19. The method of claim 17, further comprising:
processing means to calculate and update said differentiation means based on display status as measured by said detection means.

20. The method of claim 17, further comprising:
scrolling means whereby said differentiation means can be grabbed and moved by a point and click device as used in conjunction with the user interface, resulting in moving said data file section and differentiation means with respect to said viewing area.
